(19) United States
(12) Patent Application Publication
(10) Pub. No.: US 2020/0195068 A1
(43) Pub. Date: Jun. 18, 2020

(54) INTERIOR PERMANENT MAGNET MOTORS ROTOR DESIGN FOR REDUCED ROTOR INERTIA AND ARMATURE REACTION MITIGATION

(71) Applicant: Thunder Power New Energy Vehicle Development Company Limited, Central (HK)

(72) Inventor: Frank LIN, Taipei City (TW)

(21) Appl. No.: 16/702,581

(22) Filed: Dec. 4, 2019

Related U.S. Application Data
(60) Provisional application No. 62/778,306, filed on Dec. 12, 2018.

(51) Int. Cl. H02K 1/27; H02K 21/14; H02K 7/00

(52) U.S. Cl. CPC H02K 1/276; B60L 50/66; H02K 7/006; H02K 21/14

(57) ABSTRACT

A rotor includes a rotor core forming a cylindrical body and a plurality of equally-sized circular sectors, where each of the equally-sized circular sectors includes three slots. A first slot configured to house a first magnetic bar includes a first long axis that is oriented in a radial direction in the rotor core. A second slot configured to house a second magnetic bar includes a second long axis that is oriented in the radial direction in the rotor core, where the second slot is sized the same as the first slot. A third slot configured to house a third magnetic bar includes a third long axis that is oriented circumferentially along an out circumferential edge of the rotor core between the first slot and the second slot.

### CROSS-REFERENCES TO RELATED APPLICATIONS

The present application claims priority to U.S. Patent Application No. 62/778,306, filed on Dec. 12, 2018, entitled “INTERIOR PERMANENT MAGNET MOTORS ROTOR DESIGN FOR REDUCED ROTOR INERTIA AND ARMATURE REACTION MITIGATION”, which is incorporated by reference herein for all purposes.

### BACKGROUND

Internal permanent magnet (IPM) motors are synchronous motors with rotating magnetic fields that have magnets embedded in the rotors of the motor. These motors can use both the torque due to the magnet magnetization and the reluctance torque due to the rotor magnetization. Since the magnets are typically embedded in rotors made from robust materials, such as silicon steel plates, the centrifugal force during the motor rotation typically does not dislodge the magnets from their positions, which results in high mechanical stability. Some IPM motors allow for control of the current phase to run with high torque over a wide range of speeds. This makes these motors very energy-efficient, while still allowing for a high torque output. Recently, the use of IPM motors has been expanding rapidly in electric vehicles, hybrid vehicles, and/or other transportation applications.

One of the challenges that arises during the use of IPM motors is that use at high speeds found in many motor vehicle applications often involves difficulties in achieving the required flux-weakening capability and low vibration. IPM motor rotors that are not carefully optimized may cause noise, vibration, torque ripple, and harmonic distortion that influences controllability or iron loss, and which may increase the maximum driving current.

### BRIEF SUMMARY

In some embodiments, a rotor for an internal permanent magnet motor may include a rotor core forming a cylindrical body of the rotor. The rotor core may include a plurality of equally-sized circular sectors. Each of the equally-sized circular sectors may include a first slot configured to house a first magnetic bar, where the first slot may include a first long axis that is oriented in a radial direction in the rotor core. Each of the equally-sized circular sectors may also include a second slot configured to house a second magnetic bar, where the second slot may include a second long axis that is oriented in the radial direction in the rotor core and the second slot may be sized the same as the first slot. Each of the equally-sized circular sectors may further include a third slot configured to house a third magnetic bar, where the third slot may include a third long axis that is oriented circumferentially along an out circumferential edge of the rotor core between the first slot and the second slot.

In some embodiments, an interior permanent magnet (IPM) motor may include a stator having a plurality of conductors, the stator disposed concentrically around an axis, and at least one rotor. The at least one rotor may include a plurality of equally-sized circular sectors. Each of the equally-sized circular sectors may include a first slot configured to house a first magnetic bar, where the first slot may include a first long axis that is oriented in a radial direction in the rotor core. Each of the equally-sized circular sectors may also include a second slot configured to house a second magnetic bar, where the second slot may include a second long axis that is oriented in the radial direction in the rotor core and the second slot may be sized the same as the first slot. Each of the equally-sized circular sectors may further include a third slot configured to house a third magnetic bar, where the third slot may include a third long axis that is oriented circumferentially along an out circumferential edge of the rotor core between the first slot and the second slot.

In any embodiments, any of the following features may be included in any combination and without limitation. Each of the equally-sized circular sectors may include an alignment hole positioned closer to a center of the rotor than the first slot or the second slot. The spacing between the alignment holes need not be uniform. The third slot may be positioned adjacent to an outer circumference of the rotor core. The first slot may include a rectangular portion that is shaped to house the first magnetic bar. The first slot further may include air gaps extending from short sides of the rectangular portion. The third slot may include a rectangular portion that is shaped to house the third magnetic bar. The third slot further may include air gaps extending from short sides of the rectangular portion. Each of the equally-sized circular sectors may include an air gap positioned between the first slot in the second slot and positioned below the third slot. The plurality of equally-sized circular sectors may include 12 circular sectors.

### BRIEF DESCRIPTION OF THE DRAWINGS

A further understanding of the nature and advantages of the present disclosure may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a simplified block diagram of an electric vehicle, according to some embodiments.

FIG. 2 illustrates a schematic of the motor, according to some embodiments.

FIG. 3 illustrates a schematic of a rotor assembly, according to some embodiments.

FIG. 4 illustrates a cross-sectional view of a single rotor, according to some embodiments.

FIG. 5 illustrates a view of the rotor placed inside of the stator with stator windings and permanent magnets inserted therein, according to some embodiments.

FIG. 6 illustrates a detailed view of an outer portion of one circular sector of the rotor, according to some embodiments.

FIG. 7 illustrates a detailed view of an inner portion of one circular sector of the rotor, according to some embodiments.

FIG. 8 illustrates a diagram of the magnetic flux distribution at a predetermined test current, according to some embodiments.

FIG. 9 illustrates a diagram of a rotor stress analysis test performed at 16,000 RPM, according to some embodiments.

### DETAILED DESCRIPTION

Described herein, are embodiments for a rotor design for an IPM motor with air gaps, alignment holes, and magnet slots that are geometrically configured to simultaneously optimize the rotational inertia of the rotor and mitigate the armature reaction that would otherwise be present in the motor. The rotor design may be characterized by a pair of magnet slots that are arranged to be parallel to lines radiating outward from a center of the rotor. The rotor design may also include a third magnet slot that is arranged perpendicular to lines radiating outward from the center of the rotor and centered between the pair of magnet slots. As will described in greater detail below, a rotor may include a rotor core forming a cylindrical body of each rotor. The rotor core may include a plurality of equally-sized circular sectors, and each of the equally-sized circular sectors may include a first slot configured to house a first magnetic bar where a long axis is oriented in a radial direction in the rotor core. The rotor core may also include a second slot configured to house a second magnetic bar with a long axis that is oriented in the radial direction in the rotor core. A third slot may configured to house a third magnetic bar, and a long axis may be oriented circumferentially along an outer circumferential edge of the rotor core between the first slot and the second slot.

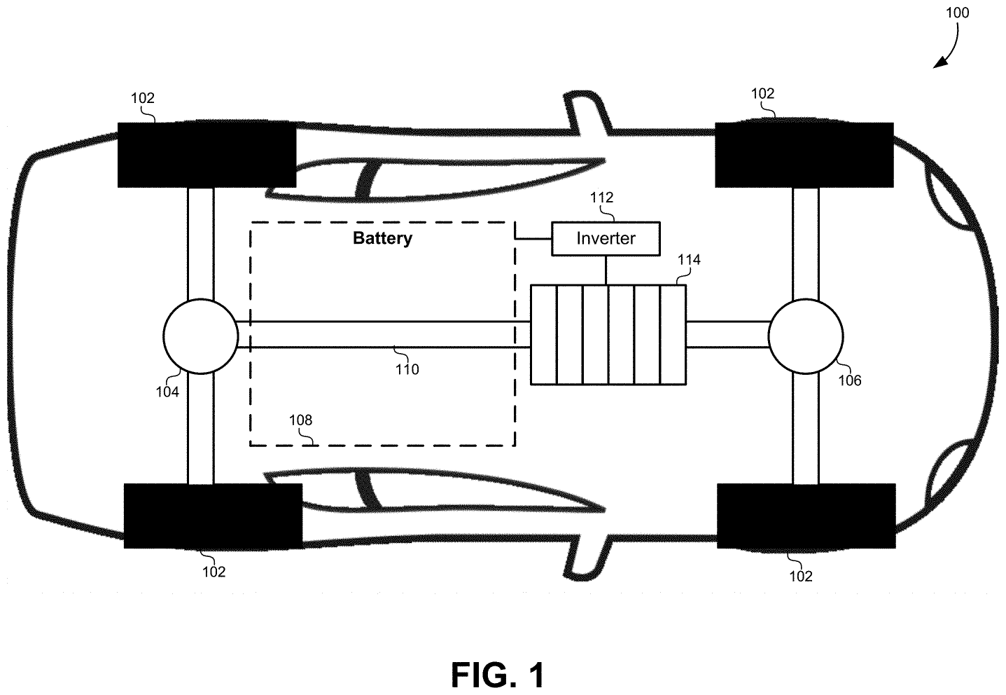

FIG. 1 illustrates a simplified block diagram of an electric vehicle 100, according to some embodiments. High-intensity permanent magnets enable technological advances for developing small, high-powered IPM motors for many different high-volume applications. One of the most important areas of IPM development is in the drivetrain of hybrid or electric vehicles. IPM motors are particularly well-suited for the electric vehicle drivetrain because they generally produce high output torque given the small physical size of the motor, while using a relatively small input voltage. IPM motors are also very mechanically reliable because the internal placement of the magnetic bars are generally very secure and withstand the high rotation rates of the rotors.

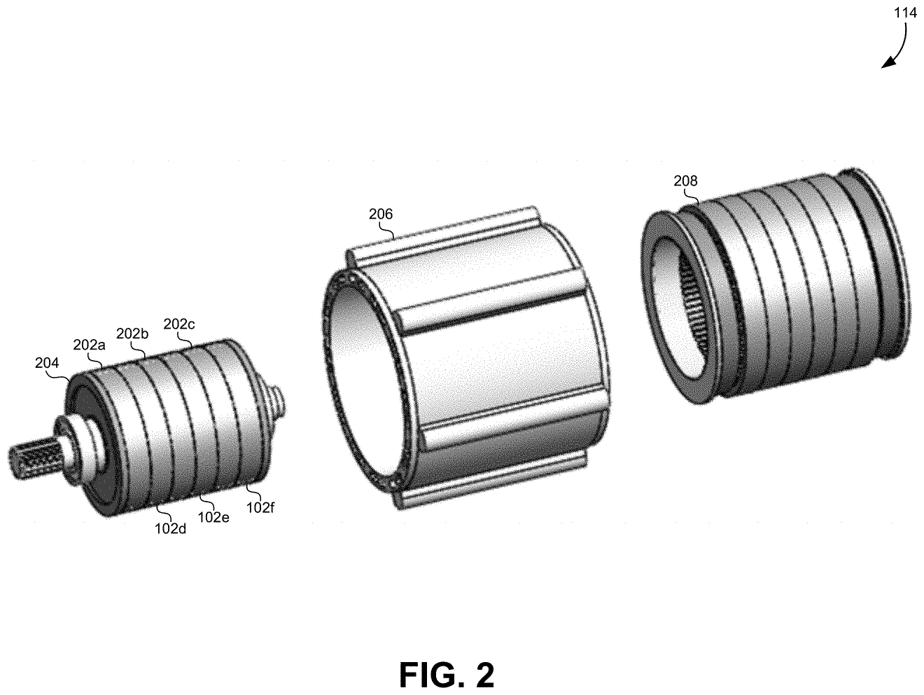

In FIG. 1, an electric vehicle 100 is depicted having an IPM motor 114. The motor 114 includes a plurality of individual rotors that are stacked together on axis and inserted into a hollow stator, which will be described in greater detail below in relation to FIG. 2. The motor 114 may be powered by a rechargeable battery 108. The rechargeable battery 108 may be constructed from a large number of individual lithium-ion cells, for example. Each of the individual battery cells may be connected in series/parallel combinations to provide a large amount of instantaneous current to the motor 114. The electric vehicle 100 may also include an inverter 112 that generates one or more AC voltage signals that may be used to drive the motor 114. For example, magnets in the rotors of the motor 114 may be used to generate a constant motor flux, while the AC current provided by the inverter 112 generates the rotating magnetic field the causes the magnets to rotate the rotors based on the speed of the field rotation.

The electric vehicle 100 may also include a drive shaft 110 that may include one or more differential units 104, 106, axles, and/or steering mechanisms. The drive shaft 110 may be rotated by virtue of its connection to the rotors of the motor 114. The differential units 104, 106 can translate the axial rotation of the drive shaft 110 into a corresponding rotation of the wheels 102. FIG. 1 illustrates how the battery 108 provides electrical power through the inverter 112, and how the motor 114 converts the electrical power into physical rotation of the rotors to turn the drive shaft 110 and the wheels 102. It should be noted that in some embodiments, the motor 114 may also be configured to operate as an energy generator in hybrid electric vehicles when the wheels 102 are turned by an external power supply, such as an internal combustion engine.

FIG. 2 illustrates a schematic of the motor 114, according to some embodiments. The motor 114 may include a housing 206, a stator 208, and a rotor assembly 204, along with other electrical and/or mechanical components. The housing 206 may be used to mount the components of the motor 114 to the interior of the electric vehicle 100. The housing 206 may also protect and encase the internal electronics and windings of the stator 208. An IPM motor 114 is powered by an AC voltage source and uses magnets embedded in the interior of the rotor assembly 204 to respond to a rotating magnetic field generated by the windings in the stator 208. The flow of electric current through the stator 208 creates a magnetic field. The AC current flowing through the windings of the stator 208 generates a magnetic field according to Maxwell's well-known equations of electromagnetics. This generates a magnetic flux defined as the rate of a magnetic field flowing through a cross-sectional area of the internal space defined by the stator 208. Magnetic flux may also be generated by the permanent magnets embedded in the rotor assembly 204. Flux linkage occurs when a magnetic field interacts with another material, and here generally refers to how well the magnetic flux generated inside the motor 114 is translated into rotational motion of the rotor 204.

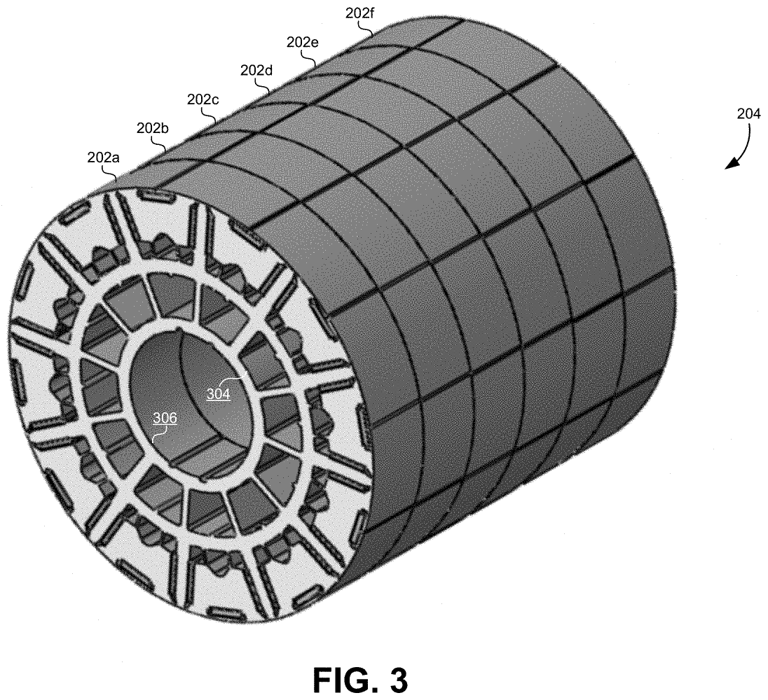

FIG. 3 illustrates a schematic of a rotor assembly 204, according to some embodiments. The rotor assembly 204 may be constructed using a plurality of individual rotors 202a, 202b, 202c, 202d, 202e, and 202f To construct of the rotor assembly 204, each of the rotors 202 may be mounted on a central axle that is inserted into a center hole of the rotors 202. Each of the rotors 202 may be held against each other to form what would electrically be considered a single metal mass for the rotor assembly 204. Alternatively or additionally, each of the rotors 202 may be mounted on a plurality of shafts that are inserted into the alignment holes 304 surrounding the center hole 306 of the rotors 202. Building the rotor assembly 204 out of a plurality of individual rotors 202 allows for very precise machining of the individual rotors 202 that would otherwise be difficult for a solid metal mass.

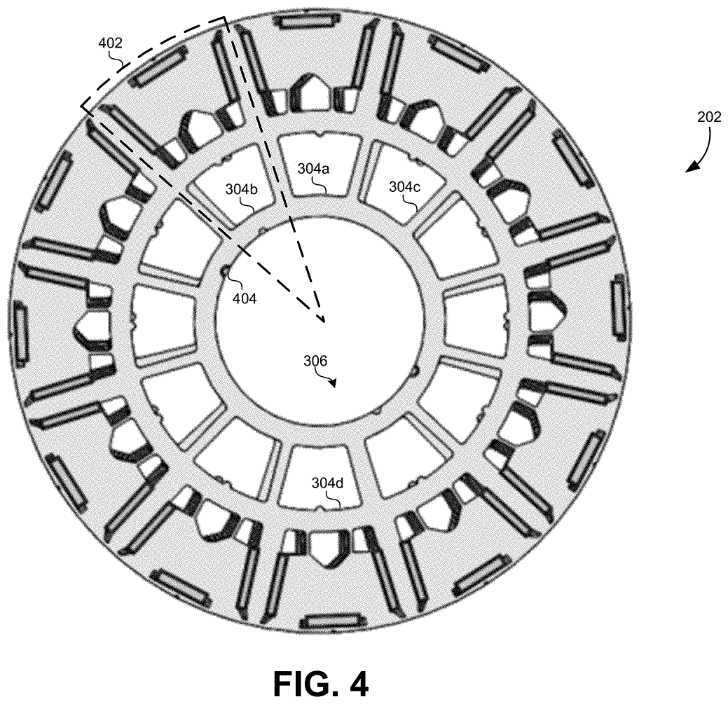

FIG. 4 illustrates a cross-sectional view of a single rotor 202, according to some embodiments. The rotor 202 may include a rotor core forming a cylindrical body of the rotor. The rotor core includes the volume of metal that fills the cylinder shown in the cross-sectional illustration of FIG. 4. The cylindrical body of the rotor 202 refers to the general shape of the rotor, which appears as a disc in this cross-sectional view, but which has a clearly cylindrical external shape as illustrated above in FIG. 3. The rotor 202 may also include a cylindrical center hole 306 that is centered in the rotor 202. As described above, the center hole 306 can be used to mount the rotor 202 to a center axle that is linked to the drive shaft. In some embodiments, the center hole 306 may include alignment cutouts 404 that are used to align the placement of the rotor 202 in relation to other rotors in the rotor assembly 204. For example, the center axle may include corresponding protrusions that mate with the alignment cutouts 404 to properly align the plurality of rotors relative to each other.

The rotor 202 may be conceptually divided into a plurality of equally-size circular sectors. As used herein, the term “circular sector” adheres to the generally accepted geometric definition of a portion of a disc or cylinder enclosed by two radii and an arc. For example, FIG. 4 illustrates one circular sector 402 of the rotor 202. The slots, cutouts, alignment holes, and other geometric features of the circular sector 402 may be repeated around the rotor 202 for a total of 12 circular sectors. The 12 circular sectors depicted in FIG. 4 are merely exemplary and not meant to be limiting. Other embodiments may use more or fewer circular sectors, such as 10 sectors, 8 sectors, 7 sectors, 14 sectors, 15 sectors, 18 sectors, and/or the like. Additionally, some embodiments may use circular sectors that are exactly identical, while other embodiments may use slight variations in the placement of the features in each sector. For example, the placement of the alignment holes 304 may be spaced slightly differently within each sector to be used during an alignment procedure when assembling the plurality of rotors in the rotor assembly 204. In that case, each of the alignment holes 304 may be similarly or identically sized, symmetrically aligned with respect to a corresponding alignment hole on the opposite side of the rotor 202, but spaced differently with respect to adjacent alignment holes. For example, alignment holes 304a, 304b, 304c may each be sized similarly or identically. However, the space between alignment holes 304a and 304b may be different than the space between alignment holes 304a and 304c. However, alignment holes 304a and 304d may be symmetric relative to a center diameter of the rotor 202.

Above the alignment holes 304 in each circular sector 402, the rotor 202 may include slots and/or air gaps configured to securely receive and hold permanent magnets to interact with the magnetic flux generated by the stator 208. Many different configurations for the slots and air gaps are possible. However, the geometric arrangement, spacing, sizing, orientation, angles, and features of the slots and air gaps described herein are designed to maximize the flux linkage, minimize the armature reaction, and reduce the rotational inertia of the rotor 202.

Generally, the slots and air gaps in each circular sector 402 may be substantially similar in their size and/or placement. As used herein, the term “substantially” or “substantially similar” may be interpreted as varying by less than 10% in size and/or location. Therefore, the description below focuses on a single circular sector 402, but it will be understood that this discussion applies to each of the circular sectors as they occur radially around the rotor 202.

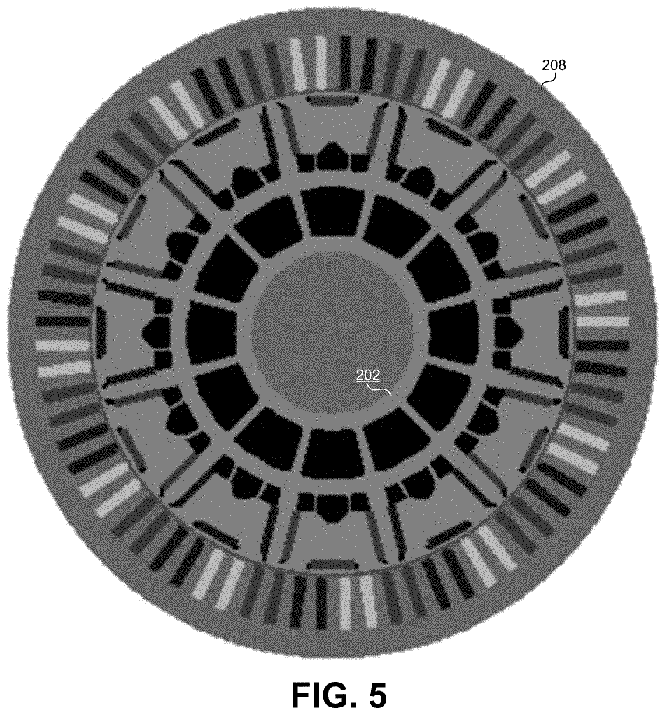

FIG. 5 illustrates a view of the rotor 202 placed inside of the stator 208 with stator windings and permanent magnets inserted therein, according to some embodiments. Each of the circular sectors of the rotor 202 has slots that are filled with permanent magnets having the same orientation and/or polarity. The shading of the permanent magnets indicates the orientation. Generally, the permanent magnets may be placed in alternating orientations in adjacent circular sectors. Additionally, the shading of the windings in the stator 208 illustrate the different winding configurations.

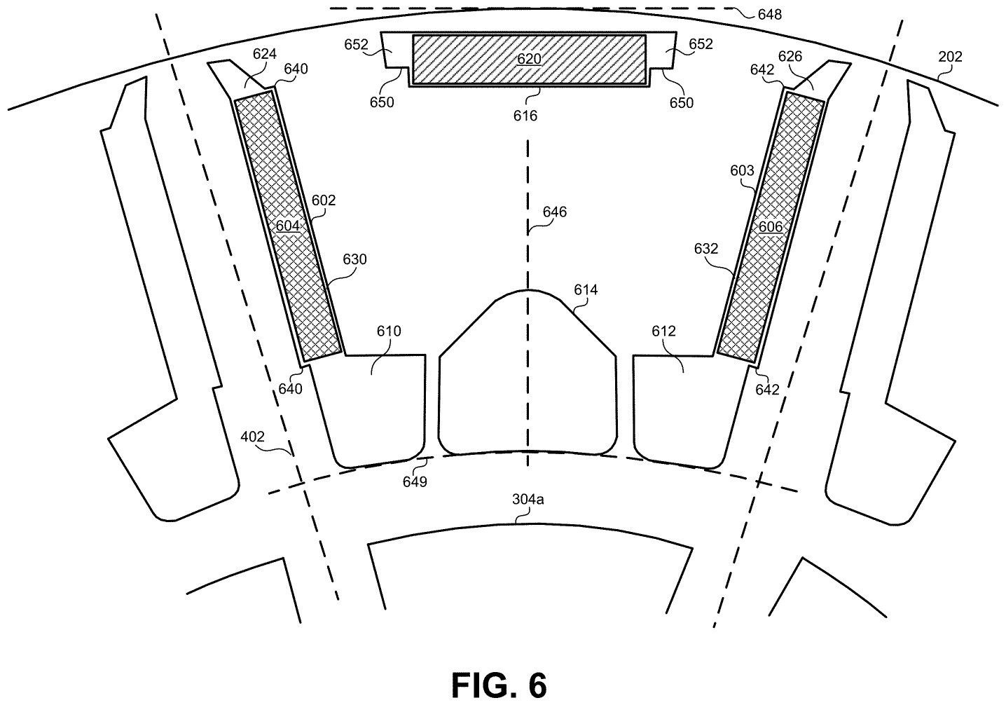

FIG. 6 illustrates a detailed view of an outer portion of one circular sector 402 of the rotor 202, according to some embodiments. This circular sector 402 includes a first slot 602 that is configured to house a first magnetic bar 604. In some embodiments, the first magnetic bar 604 may be a single piece of material, while in other embodiments the first magnetic bar 604 may comprise a plurality of rods or bars. The first slot may have a substantially rectangular portion 630 that is configured to receive the magnetic bar 604 or bars. The rectangular portion 630 may have a long axis and a short axis according to the common definition of a rectangle. The long axis may be substantially aligned with a radial direction emanating out from a center point of the rotor 202. “Substantially aligned” implies that an angle formed between the long axis of the rectangular portion 630 and a radial line emanating from the center of the rotor 202 varies by less than 10°.

The first slot 602 may be generally open along both of the smaller sides of the rectangular portion 630. However, at least one corner in each of the smaller sides may include a ledge 640 configured to hold the magnetic bar 604 in place. At the top, or circumferential, side of the first slot 602 corresponding to one of the smaller sides of the rectangular portion 630, the first slot 602 may include an air gap 624 that extends towards the outer circumference of the rotor 202. The air gap 624 may include, for example, three angled sides as depicted in FIG. 6. Regarding the angles formed by the air gap 624 and all other geometric features of the rotor 202, FIG. 6 may be considered drawn to scale. For example, relative to a radius of the rotor 202, an outside edge of the air gap 624 may form an angle between 5° and 15°, and an inside edge of the air gap 624 may form an angle between 25° and 35° with the corresponding edge of the rectangular portion 630. A top edge of the air gap may be within 10° of being tangential to the circumference of the rotor 202.

In addition to the air gap 624 at the top of the first slot 602, the first slot 602 may include another air gap 610 that is connected to the bottom the rectangular portion 630. A top edge of the air gap 610 may be substantially straight and parallel to a tangent 648 to the circumference of the rotor 202 that would occur at the bisected center of the circular sector 402. The left edge of the air gap 610 may be approximately parallel to the left edge of the rectangular portion 630, but offset by the size of the step 640. The left edge of the air gap 610 may also be approximately aligned with a radius emanating from a center point of the rotor 202. A right edge of the air gap 610 may be parallel to a radial line 646 that would bisect the circular sector 402. A bottom edge of the airgap 610 may be aligned with an arc 649 at a predetermined radius about the center of the rotor 202.

Each of the corners or edge intersections of the first slot 602 may be sharp corners or rounded as depicted in FIG. 6. Alternatively, any of the sharp corners may also be rounded, and/or the rounded corners may be made sharp without limitation and in any combination, although not shown explicitly in FIG. 6. The corner geometries may be tailored according to each application as needed. It should also be noted that the magnetic bar 604 need not be an integral or permanent part of the rotor 202. Instead, the magnetic bar 604 can be added or removed at any time. In some embodiments, the magnetic bar 604 can be secured in the rectangular portion 630 of the first slot 602 using epoxy, glues, solder, padding, or other adhesives/fillers to minimize any movement and/or vibration of the magnetic bar 604.

In addition to the first slot 602, each circular sector 402 may also include a second slot 603. The second slot may be a mirror image of the first slot 602. For example, the rectangular portion 632, the airgap 626, the airgap 612, the steps 642, and so forth, may be sized and/or arranged as described above with their orientation reversed and rotated about the center point of the rotor 202 such that they are placed as depicted in FIG. 6. The second slot 603 may be configured to receive a second magnetic bar 606 in the same manner that the first slot 602 is configured to receive the magnetic bar 604.

Each circular sector 402 may also include a third slot 616 that is configured to receive a third magnetic bar 620. A bottom edge of the third slot 616 may be substantially parallel to the tangent 648 to the circumference of the rotor 202 at the bisected center of the circular sector 402. Similarly, a top edge of the third slot 616 may also be substantially parallel to the same tangent 648. The left and right sides of the third slot 616 may include steps 650 that secure the third magnetic bar 620 in place. The left and right sides of the third slot 616 may also include airgaps 652 with top and bottom edges that are also parallel to the tangent 648 described above in which extend from the section housing the third magnetic bar 620. The outer edges of the airgaps may be parallel to radial lines emanating from the center of the rotor 202. The third slot 616 may be centered between the first slot 602 in the second slot 603. The distance from the circumference of the rotor 202 to the top of the third slot 616 may be within 25% of the distance between the circumference of the rotor 202 and the top of the first/second slots 602, 603. FIG. 6 illustrates a sample of this placement drawn to scale.

In addition to the three slots 602, 603, 616, some embodiments may also include one or more additional airgaps 614. A bottom portion of the airgap 614 may be aligned with the arc 649 at the predetermined radius about the center of the rotor 202 such that it lies in the same arc line as the bottom portions of airgaps 610 and 612. The left and right edges of the airgap 614 may be parallel to the bisector 646 of the circular sector 402 described above. The top edge of the airgap 614 may include two straight portions that are oriented at angles of between 30° and 60° relative to the tangent 648 line described above. For example, the straight portions in FIG. 6 may be oriented at approximately 45° relative to the tangent 648 line. These two straight portions may be connected by a curved radius as depicted in FIG. 6. Each of the corners or edge intersections of the airgap 614 may be rounded or straight as illustrated in FIG. 6. Additionally, any of the straight corners may be substituted with rounded corners and vice versa as needed.

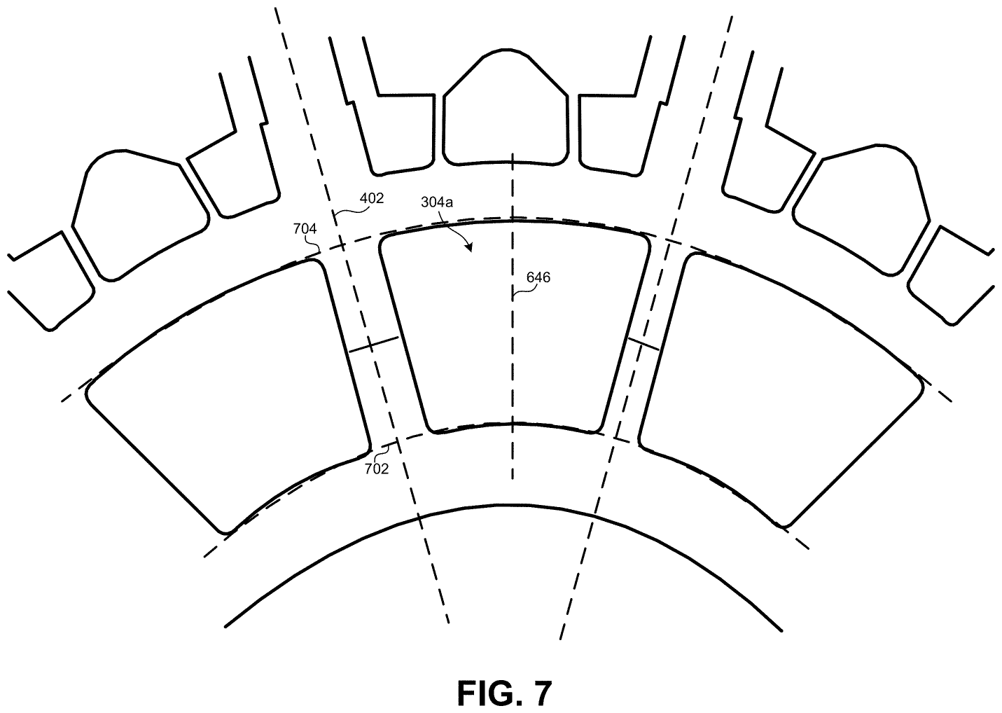

FIG. 7 illustrates a detailed view of an inner portion of one circular sector 402 of the rotor 202, according to some embodiments. The outer portion of the circular sector 402 is also partially visible at the top of FIG. 7, however the view has shifted to the inner portion of the circular sector 402 to focus on the geometry of the alignment hole 304a. Each circular sector may include one or more alignment holes 304, although this example focuses on a specific alignment hole 304a. As described above, the alignment hole 304a may be used to reduce the mass of the rotor 202 to reduce the rotational inertia of the rotor 202. The alignment hole 304a may also be used as a feature that is mated with a rod that ensures that the plurality of rotors in the rotor assembly 204 are aligned correctly relative to each other.

The geometry of the alignment hole 304a may be formed according to the illustration in FIG. 7. In this example, a top edge and a bottom edge of the alignment hole 304a may follow an arc path around the center of the rotor 202 at predetermined radii. For example, the top edge of the alignment hole 304a may follow arc 704, and the bottom edge of the alignment hole 304a may follow arc 702. The left and right edges of the alignment hole may follow radial lines that extend outward from a center of the rotor 202. As described above, each of the corners of the alignment hole 304a may be rounded as depicted in FIG. 7 with a predetermined radius, or may alternatively use sharp corners.

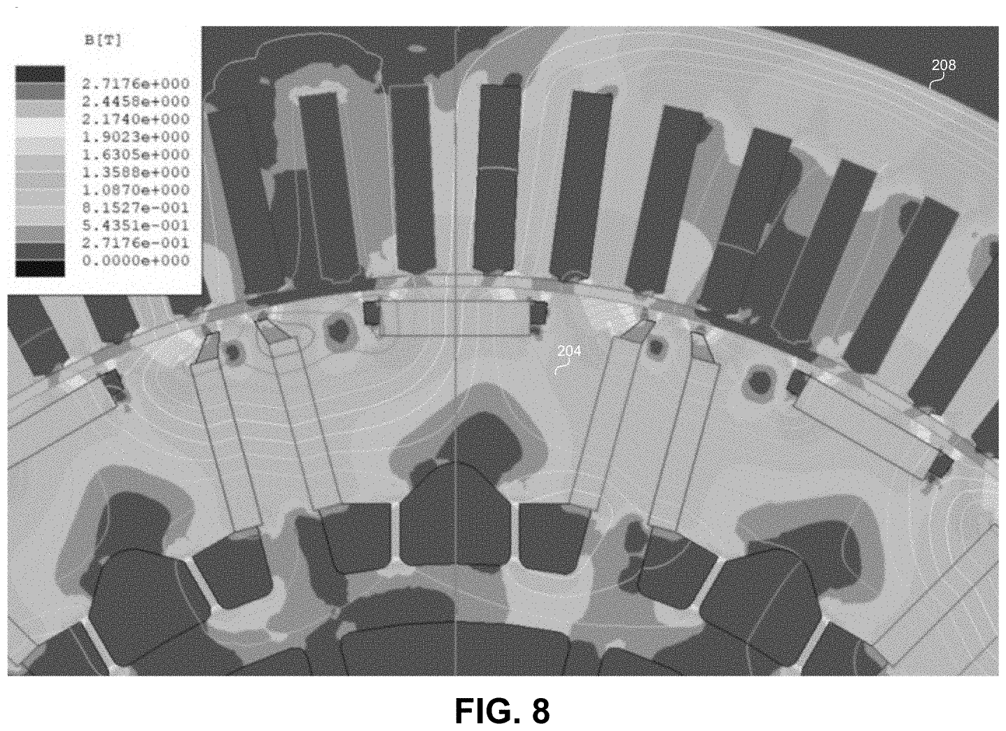

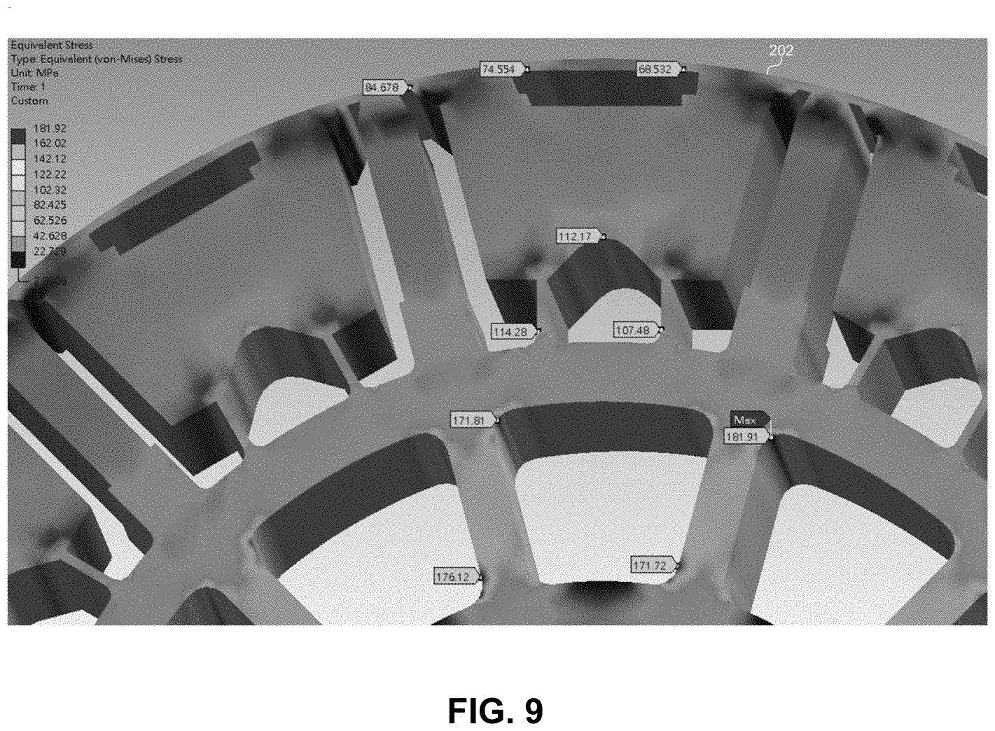

FIG. 8 illustrates a diagram of the magnetic flux distribution at a predetermined test current, according to some embodiments. As described above, one of the many advantages provided by this rotor design is to optimize the magnetic flux distribution within the rotor 202 and stator 208 combination. This figure illustrates how the magnetic flux is concentrated around the circumferential edge of the rotor 202. This figure also illustrates the effect of the placement of the airgaps on the magnetic flux distribution. The magnetic flux measured in FIG. 9 is the result of a 600 amp current provided to the stator 208.

FIG. 9 illustrates a diagram of a rotor stress analysis test performed at 16,000 RPM, according to some embodiments. The rotor stress analysis illustrates how this particular rotor design is able to reduce the mass of the rotor 202 and thereby reduce the rotational inertia without compromising the structural integrity of the rotor 202 even at excessive rotational speeds. This configuration also allows the majority of the mass to be closer to the circumferential edge of the rotor 202 to provide efficiency a constant speeds without significantly negatively affecting the acceleration speed of the motor.

In the foregoing description, for the purposes of explanation, numerous specific details were set forth in order to provide a thorough understanding of various embodiments of the present disclosure. It will be apparent, however, to one skilled in the art that embodiments of the present disclosure may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of the exemplary embodiments will provide those skilled in the art with an enabling description for implementing an exemplary embodiment. It should be understood that various changes may be made in the function and arrangement of elements without departing from the spirit and scope of the disclosure as set forth in the appended claims.

Specific details are given in the foregoing description to provide a thorough understanding of the embodiments. However, it will be understood by one of ordinary skill in the art that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A rotor for an internal permanent magnet motor, the rotor comprising:
a rotor core forming a cylindrical body of the rotor, wherein the rotor core comprises a plurality of equally-sized circular sectors, and wherein each of the equally-sized circular sectors comprises:
a first slot configured to house a first magnetic bar, wherein the first slot comprises a first long axis that is oriented in a radial direction in the rotor core;
a second slot configured to house a second magnetic bar, wherein the second slot comprises a second long axis that is oriented in the radial direction in the rotor core, and wherein the second slot is sized the same as the first slot; and
a third slot configured to house a third magnetic bar, wherein the third slot comprises a third long axis that is oriented circumferentially along an out circumferential edge of the rotor core between the first slot and the second slot.

2. The rotor of claim 1, wherein each of the equally-sized circular sectors further comprises:
an alignment hole positioned closer to a center of the rotor than the first slot or the second slot.

3. The rotor of claim 2, wherein the spacing between the alignment holes is not uniform.

4. The rotor of claim 1, wherein the third slot is positioned adjacent to an outer circumference of the rotor core.

5. The rotor of claim 1, wherein the first slot comprises a rectangular portion that is shaped to house the first magnetic bar.

6. The rotor of claim 5, wherein the first slot further comprises air gaps extending from short sides of the rectangular portion.

7. The rotor of claim 1, wherein the third slot comprises a rectangular portion that is shaped to house the third magnetic bar.

8. The rotor of claim 7, wherein the third slot further comprises air gaps extending from short sides of the rectangular portion.

9. The rotor of claim 1, wherein each of the equally-sized circular sectors further comprises:
an air gap positioned between the first slot in the second slot and positioned below the third slot.

10. The rotor of claim 1, wherein the plurality of equally-sized circular sectors comprises 12 circular sectors.

11. An interior permanent magnet (IPM) motor comprising:
a stator having a plurality of conductors, the stator disposed concentrically around an axis;
at least one rotor disposed concentrically around the axis inside of the stator, the at least one rotor comprising a rotor core forming a cylindrical body of the rotor, wherein the rotor core comprises a plurality of equally-sized circular sectors, and wherein each of the equally-sized circular sectors comprises:
a first slot configured to house a first magnetic bar, wherein the first slot comprises a first long axis that is oriented in a radial direction in the rotor core;
a second slot configured to house a second magnetic bar, wherein the second slot comprises a second long axis that is oriented in the radial direction in the rotor core, and wherein the second slot is sized the same as the first slot; and
a third slot configured to house a third magnetic bar, wherein the third slot comprises a third long axis that is oriented circumferentially along an out circumferential edge of the rotor core between the first slot and the second slot.

12. The motor of claim 11, wherein each of the equally-sized circular sectors further comprises:
an alignment hole positioned closer to a center of the rotor than the first slot or the second slot.

13. The motor of claim 12, wherein the spacing between the alignment holes is not uniform.

14. The motor of claim 11, wherein the third slot is positioned adjacent to an outer circumference of the rotor core.

15. The motor of claim 11, wherein the first slot comprises a rectangular portion that is shaped to house the first magnetic bar.

16. The motor of claim 15, wherein the first slot further comprises air gaps extending from short sides of the rectangular portion.

17. The motor of claim 11, wherein the third slot comprises a rectangular portion that is shaped to house the third magnetic bar.

18. The motor of claim 17, wherein the third slot further comprises air gaps extending from short sides of the rectangular portion.

19. The motor of claim 11, wherein each of the equally-sized circular sectors further comprises:
an air gap positioned between the first slot in the second slot and positioned below the third slot.

20. The motor of claim 11, wherein the plurality of equally-sized circular sectors comprises 12 circular sectors.
